(19) United States
(12) Patent Application Publication
(10) Pub. No.: US 2014/0075074 A1
(43) Pub. Date: Mar. 13, 2014

(54) ELECTRONIC DATA EXCHANGE DEVICE

(71) Applicant: CHUN-HENG LEE, TAOYUAN COUNTY (TW)

(72) Inventor: CHUN-HENG LEE, TAOYUAN COUNTY (TW)

(73) Assignee: OWITEK TECHNOLOGY LTD., TAOYUAN COUNTY (TW)

(21) Appl. No.: 13/608,010

(22) Filed: Sep. 10, 2012

(51) Int. Cl. G06F 13/00

(52) U.S. Cl. 710/302

(57) ABSTRACT

An electronic exchange is applied for a portable electronic device is provided, which includes an exchange unit and a loading portion, which is provided for loading a SIM card. The loading portion is positioned in the portable electronic device. SIM card is electrically connected with the SIM interface of the portable electronic device. The exchange unit includes an antenna and an exchange module on the loading portion, in which the antenna is electrically connected with the exchange module. The exchange unit is electrically connected with the SWP pin of the SIM card, and is electrically isolated from the SWP corresponding contact of the SIM interface corresponding to the SWP pin.

### FIELD OF THE INVENTION

The present invention relates to an electronic data exchange device, and in particular to an electronic payment device, a reader, or a peer-to-peer exchange device is combined with an electronic device of a portable electronic device via SIM (Subscriber Identity Module).

### BACKGROUND OF THE INVENTION

Electronic data exchange for example, an electronic payment device, a reader and a peer-to-peer exchange device is convenience for the people's life.

According to statistic, each people hold more than one portable electronic device, and especially utilizes SIM (Subscriber Identity Module) card for electrically connecting with internet via wireless. The portable electronic device such as mobile device, tablet pc, E-book reader, and notebook. Obviously, it is important for everyone utilizes the portable electronic device with wireless internet access. Most users still remain in the use of function of portable electronic devices. Thus, the electronic data exchange is combined with portable electronic equipment so as to increase the convenience in the related operation of the electronic data exchange device.

The electronic payment device is combined with the mobile device which has been developed in the prior art. However, a processor unit such as controller or microcontroller must be added in the middle of the SIM card and mobile phone, such that the cost cannot be reduced. In addition, the additional processor unit will cause the signal transfer issue and higher failure during the operating. Although the prior art can achieve the purpose of electronic payment device in the mobile phone but the function is still limited by the electronic payment device which is not be able to further expand its use of function. In addition, the SIM card contact, an electronic payment device and the mobile device must be electrically connected each other accurately which is difficult before operating in the prior art. Moreover, the technology even required to change the structure of the mobile device such as antenna being exposed. Thus, the above drawbacks need to be overcome.

Therefore, how to design a device to overcome the drawbacks in the prior art is an important issue for the applicants.

### SUMMARY OF THE INVENTION

An object of the present invention is to provide an electronic data exchange device with a portable electronic device, the SWP corresponding contact (or pre-remaining corresponding contact) is replaced with the electronic data exchange device to electrically connect with the SWP pins (or pre-remaining pin) of SIM card, such that the outer device (such as a cash register or mobile telecommunications system or such as credit card or debit card) is communicated with the extended function module in the SIM card or data exchanged each other. Thus, the electronic data exchange device with the portable electronic device did not need an additional processor unit, such that the electronic data exchange device with the portable electronic device is a multifunction device, and can be used as the electronic payment device, a reader, or a peer-to-peer exchange device.

In addition, the electronic data exchange device is disposed on said portable electronic device to be a loading portion which is provided for loading a SIM card, such that the SIM card, the electronic data exchange device and the portable electronic device can combine and electrically connect with each other, and thus, the component of the portable electronic device is not to be changed.

According to above objects, the present invention provides an electronic data exchange device that is applied for a portable electronic device with a SIM interface. The SIM interface is electrically connected with a SIM card. The electronic data exchange device includes a loading portion and an exchange unit. The loading portion is provided for loading the SIM card. The loading portion includes an electrical contact region that is positioned on the portable electronic device, such that the SIM card on the loading portion is electrically connected with SIM interface through the electrical contact region. The exchange unit includes an antenna and an exchange module with a function of data exchange and data verification, in which the antenna is disposed on the loading portion and electrically connected with each other. The SIM card includes a SWP pin, and the exchange unit is electrically connected with the SWP pin of SIM card, and is electrically isolated from the SWP corresponding contact of the SIM interface corresponding to the SWP pin.

The present invention also provides another electronic data exchange device which is applied for a portable electronic device with a SIM interface. The SIM interface is electrically connected with a SIM card, and the electronic data exchange device includes a loading portion and an exchange unit. The loading portion is provided for loading the SIM card. The loading portion includes an electrical contact region that is positioned on the portable electronic device, such that the SIM card on the loading portion is electrically connected with the SIM interface through the electrical contact region. The exchange unit includes an antenna on the loading portion, in which the SIM card includes two pre-remaining pins, and the antenna is electrically connected with the two pre-remaining pins of the SIM card through the electrical contact region and is electrically isolated from the two pre-remaining corresponding contacts of the SIM interface corresponding to the two pre-remaining pins.

Thus, the electronic data device can be combined with the portable electronic device without an additional processor unit in above two electronic data exchange devices. The electronic data device can be combined with the portable electronic device which has a multifunction and can be used as the electronic payment device, a reader or a peer-to-peer exchange device. In addition, the SIM card, the electronic data exchange device and the portable electronic device can electrically contact with each other, such that the component of the portable electronic device is not to be changed, and the electrical connection can be connected accurately before operation.

In order to further understanding of the present invention of the characteristic features and technology, please refer to the following information about the detailed description of the present invention with the accompanying drawings. The drawings are provided for reference purposes only and instructions not to limit the invention.

### BRIEF DESCRIPTION OF THE DRAWINGS

The present invention will be apparent to those skilled in the art by reading the following description of a preferred embodiment thereof with reference to the drawings, in which:

FIG. 1 is an exploded perspective view of showing a mobile device in accordance with the present invention.

FIG. 2 is a side view of showing a first embodiment in accordance with the present invention.

FIG. 3 is a side view of showing a second embodiment in accordance with the present invention.

FIG. 4 is a side view of showing a third embodiment in accordance with the present invention.

FIG. 5 is a side view of showing a fourth embodiment in accordance with the present invention.

FIG. 6 is a plan view of showing one surface of a SIM card in accordance with the present invention.

FIG. 7A-FIG. 7E are the schematic diagram of showing an antenna disposed on at least five positions in accordance with the present invention.

### DETAILED DESCRIPTION OF THE PREFERRED EMBODIMENT

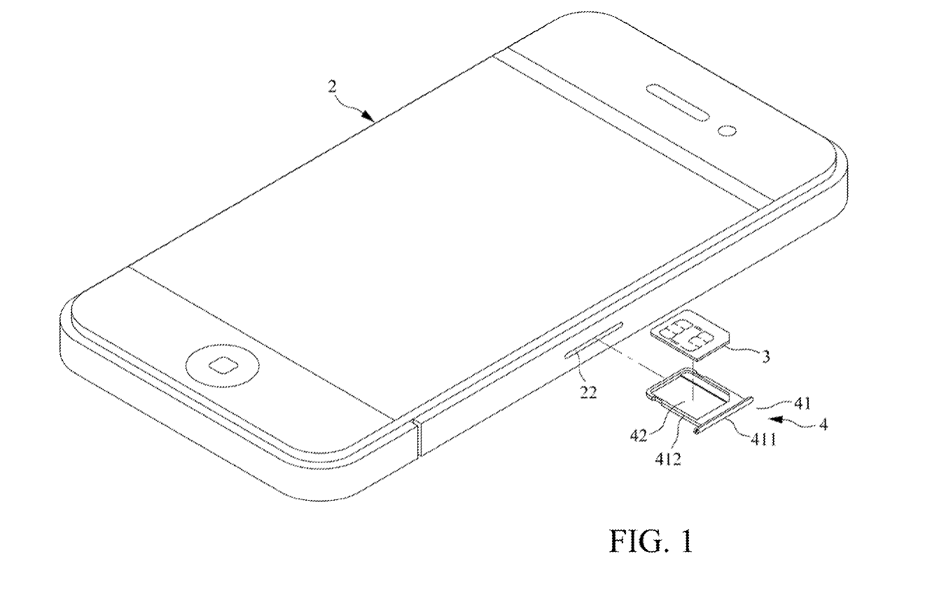

The present invention provides an electronic data exchange with a portable electronic device, in which the electronic data exchange such as an electronic payment device, a reader or a peer-to-peer exchange device. The portable electronic device is an electronic device that communicated with the Internet via wireless by using a SIM (Subscriber Identity Module) card. The electronic device such as a mobile device, a tablet, an E-book reader and a notebook. FIG. 1 shows the diagram of the mobile device, but it is not to limit in the present invention.

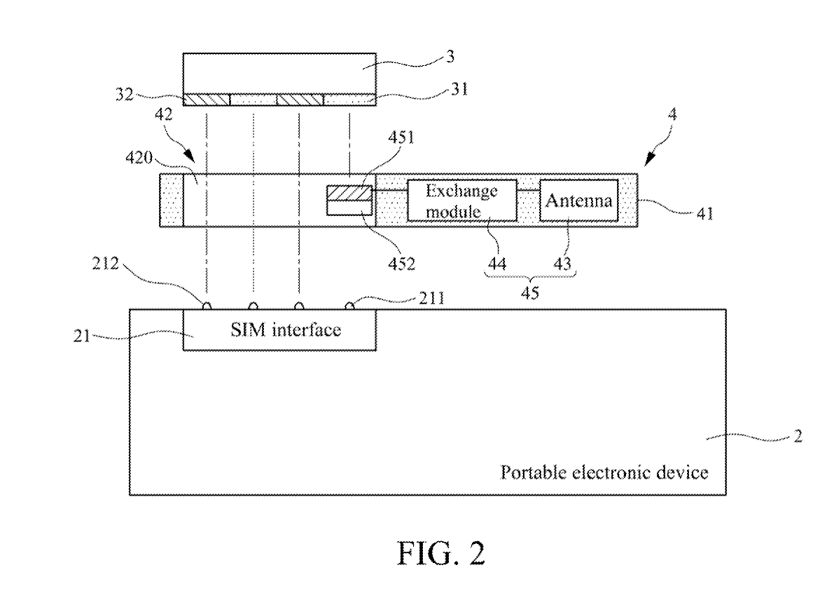

Please refer to FIG. 1 and FIG. 2, the portable electronic device 2 (for all kinds of electronic devices is electrically communicated with Internet through wireless as shown in mobile device as in FIG. 1) includes a loading portion 41 which is provided for loading a SIM card 3 (as shown in FIG. 1, the loading portion 41 is a card tray). The loading portion 41 is positioned on the portable electronic device 2 as shown in FIG. 1. The loading portion 41 is positioned in the portable electronic device 2 through slot 22. The portable electronic device 2 also includes a SIM interface 21 as shown in FIG. 2. The SIM card 3 on the loading portion 41 is positioned on the portable electronic device 2, such that the SIM card 3 is electrically connected with the SIM interface 21.

### First Embodiment

Pease refer to FIG. 2. FIG. 2 shows a first embodiment of the present invention. In FIG. 2, an antenna 43 and an exchange module 44 are disposed on the loading portion 41 at the same time, and are electrically connected with the SWP pin 31 of the SIM card 3.

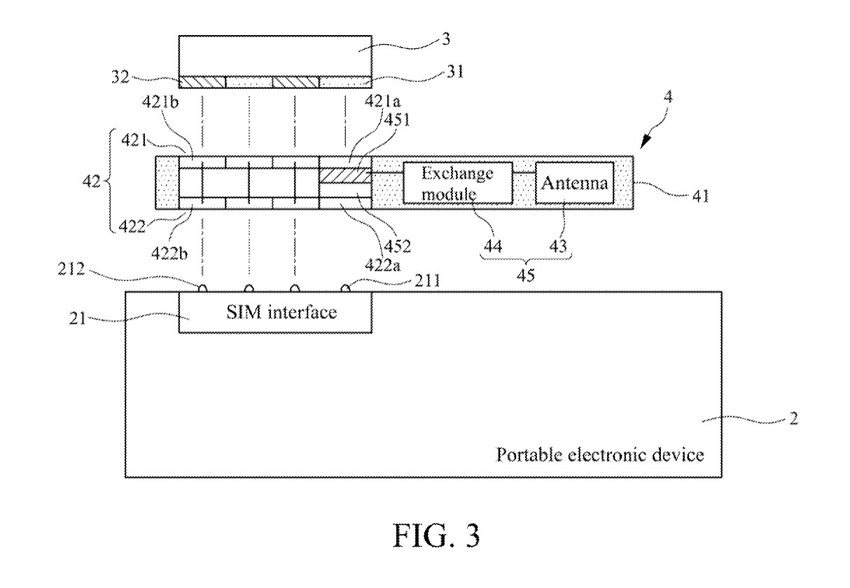

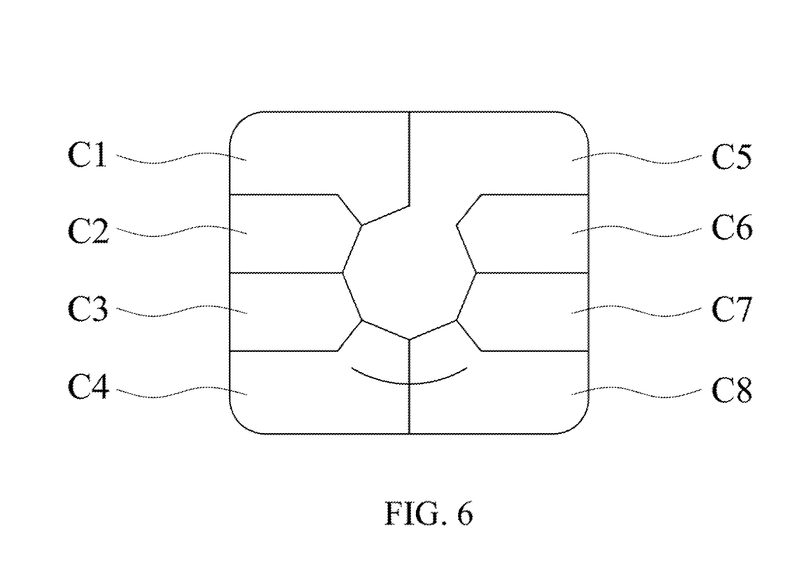

Please refer o FIG. 6. FIG. 6 is a plan view of one surface of SIM card. The SIM card 3 includes eight pins: C1 is Vcc pin (C1=Vcc pin), C2 is RST pin (C2=RST pin), C3 is CLK pin (C3=CLK pin). C4 is pre-remaining pin (C4=pre-remaining pin), C5 is ground pin (C5=GND pin), C6 is SWP pin (C6=SWP pin) (that is, the SWP pin 31 and the SWP is an abbreviation of Single Wire Protocol in the present invention), C7 is input/output pin (C7=I/O pin), and C8 is pre-remaining pin (C8=pre-remaining pin) (herein. C1˜C8 is an original symbol for each pin). In other words, SIM card 3 also includes a SWP pin 31 (that is C6=SWP pin), two pre-remaining pins (as shown in FIG. 3, that is, C4 and C8 are pre-remaining pins), and a plurality of other pins 32 (that is C1 to C3, C5 and C7 pins). The SIM interface 21 includes the corresponding number and the location of the contacts (SWP corresponding contact 211, pre-remaining contact 213 and other contacts 212).

The electronic data exchange device 4 includes a loading portion 41 and an exchange unit 45. The loading portion 41 includes an electrical contact region 41 and is provided for loading a SIM card 3. The loading portion 41 is also positioned on the portable electronic device 2 such that the SIM card 3 on the loading portion 41 is electrically connected with the SIM interface 21 through the electrical contact region 42. The exchange unit 45 includes an antenna 43 and an exchange module 44 is disposed on the loading portion 41, and the antenna 43 is electrically connected with the exchange module 44.

The exchange unit 45 is electrically connected with the SWP pin 31 of the SIM card 3 through the electrical contact region 42 and is electrically isolated from the SWP corresponding contact 211 corresponding to SWP pin 31 of the SIM interface 21. The electronic data exchange device 4 of the first embodiment of the present invention is constituted by the above-mentioned components. The electronic data exchange device 4, for example, an electronic payment device, a reader, or a peer-to-peer exchange device is combined with the portable electronic device 2 through the SIM (Subscriber Identity Module).

Please refer to FIG. 2. The conductive portion 451 is disposed on the exchange unit 45, which is electrically connected with the SWP pin 31. The conductive portion 451 also includes an insulation portion 452 which is electrically isolated from the SWP corresponding contact 211. The electrical contact region 42 includes an opening portion 420 to expose the SIM card 3, and the conductive portion 451 and the insulation portion 452. The exchange unit 45 is electrically connected with the SWP pin 31 of the SIM card 3 through the opening portion 420 and the conductive portion 451. The exchange unit 45 is electrically isolation from the SWP corresponding contact 211 of the SIM interface 21 through the opening portion 420 and the insulation portion 452.

### The Second Embodiment

Please refer to FIG. 3. The second embodiment is the same as the first embodiment, and the different between the second embodiment and the first embodiment is the electrical contact region 42, as shown in FIG. 3, the electrical contact region 42 includes a first contact interface 421, a second contact interface 422, the conductive portion 451 and the insulation portion 452, in which the first contact interface 421 and the second contact interface are disposed on two surface of the loading portion 41 respectively. The first contact interface 421 includes a first surface corresponding contact 421a corresponding to the SWP pin 31 (the first contact interface 421 also includes a plurality of others first surface corresponding contacts 421b). The second contact interface 422 includes a second surface corresponding contact 422a (the second contact interface 422 also includes a plurality of other second surface corresponding contacts 422b). The exchange unit 45 is electrically connected with the SIM pin 31 of the SIM card 3 through the first surface corresponding contact 421 and the conductive portion 451. The exchange unit 45 is also electrically isolated from the SWP corresponding contact 211 of the SIM interface 21 through the second surface corresponding contact 422a and the insulation portion 452.

In other words, the opening portion 420 of the loading portion 41 is not only an opening shape as illustrated in the first embodiment, but also a closed shape by the first contact interface 421 and the second contact interface 422 in the second embodiment.

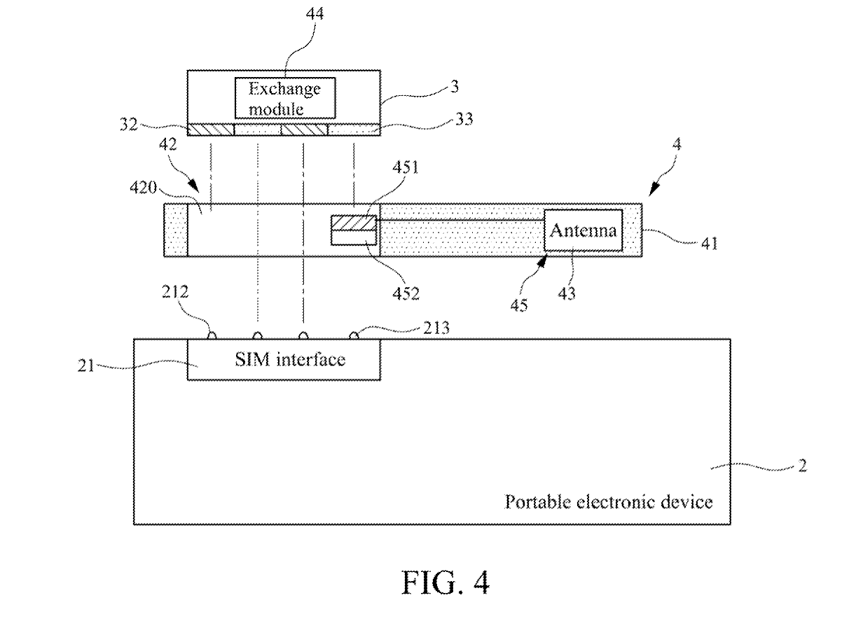

Please refer to FIG. 4 of the third embodiment of the present invention. In FIG. 4, the antenna 43 and the exchange module 44 are disposed separately and are electrically connected with the two pre-remaining pins 33 of the SIM card 3. The original symbols of the two pre-remaining pins 33 are C4 and C8 respectively (as shown in FIG. 6).

As shown in FIG. 4, the exchange unit 45 includes an antenna 43 of the loading portion 41 and an exchange module 44 with a function of the data exchange and the data verification which is built in SIM card 3. The pins of the SIM card 3 also include two pre-remaining pins 33 (the original symbol are C4 and C8 respectively). The antenna 49 is electrically connected with the two pre-remaining pins 33 of the SIM card 3 through the electrical contact region 42. The antenna 43 is electrically isolated from the two pre-remaining corresponding contacts 213 corresponding to the two pre-remaining pins 33 of the SIM interface 21 through the electrical contact region 42. The electronic data exchange device 4 of the third embodiment of the present invention is constituted by the above-mentioned components.

As shown in FIG. 4, the antenna 43 includes the conductive portion 451 and an insulation portion 452, in which the conductive portion 451 is disposed in the antenna 43 of the exchange unit 45 and is electrically connected with the two pre-remaining pins 33, and the insulation portion 452 is electrically isolated from the two-pre-remaining contacts 231. The electrical contact region 42 includes an opening portion 420, the conductive portion 451 and the insulation portion 452, in which the opening portion 420 is provided for exposing the plurality of pins 420 of SIM card 3. The antenna 43 is electrically connected with the two pre-remaining pins 33 of the SIM card 3 through the opening portion 420 and the conductive portion 451. The antenna 43 is electrically isolated from the two pre-remaining contacts 231 of the SIM interface 21 through the opening portion 420 and the insulation portion 452.

### The Fourth Embodiment

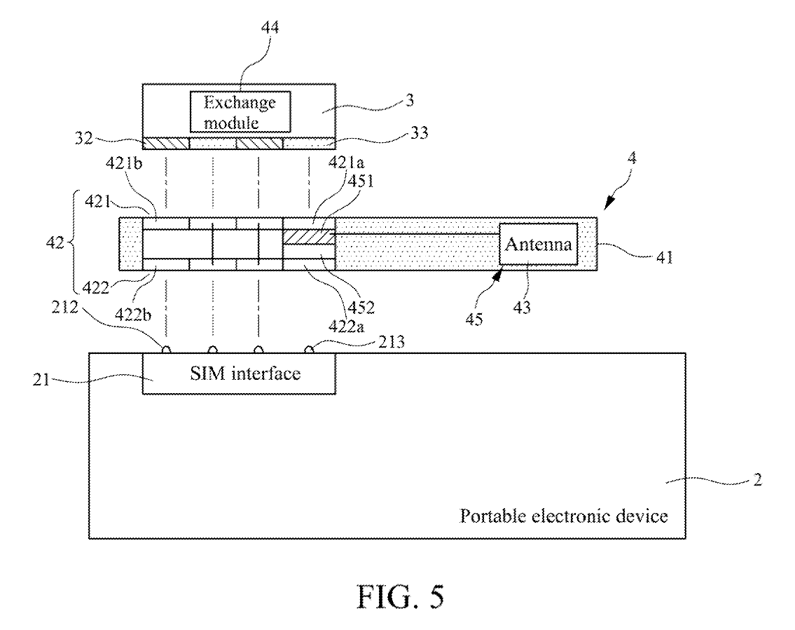

Please refer to FIG. 5. The fourth embodiment is the same as the third embodiment, and the different between the fourth embodiment and the third embodiment is electrical contact region 42.

As shown in FIG. 5, the electrical contact region 42 includes a first contact interface 421, a second contact interface 422, the conductive portion 451 and the insulation portion 452, in which the first contact interface 421 and the second contact interface 422 are disposed on two surfaces of the loading portion 41. The first contact interface 421 includes two first surface corresponding contacts 421a corresponding to two pre-remaining pins 33 (the first contact interface 421 also includes a plurality of other first surface contacts 412b). The second contact interface 422 includes two second surface corresponding contacts 422a corresponding to two pre-remaining corresponding contacts 213 (the second contact interface 4222 also includes a plurality of other second surface contacts 422b). The antenna 43 is electrically connected with the pre-remaining pin 33 of the SIM card 3 through the first surface corresponding contact 421 and the conductive portion 451. The antenna 43 is also electrically insulated from the pre-remaining pin corresponding contact 213 of the SIM interface 21 through the second surface corresponding contact 422 and the insulation portion 452.

In other words, the opening portion 420 of the loading portion 41 is not only an opening shape as illustrated in the first embodiment and the third embodiment, but also a closed shape by the first contact interface 421 and the second contact interface 422 in the second embodiment and the fourth embodiment.

In the first, second, third and fourth embodiment of the present invention, the antenna 43 is a loop antenna or RFID antenna (radio frequency identification) or other suitable antenna. In addition, the electronic data exchange device 4 of the first, second, third and fourth embodiment of the present invention can be an electronic payment device, a reader or a peer-to-peer exchange device.

The advantage of the electronic data exchange 4 of the present invention is that: first, when the electronic data exchange device is used as the electronic payment device, the portable electronic device 2 that can be used as the paid card, which can be value-added or transaction. Second, when the electronic data exchange device is used as the reader, the portable electronic device 2 can be used as the credit card machine. The portable electronic device 2 can read the Easycard to perform the micropayment. In addition, the portable electronic device 2 can read the credit card and via bank to debit. The portable electronic device 2 can also read the credit card and debit via the bank, and the debit payment can be valued by reading the Easycard. Third, when the portable electronic device 2 is used as the peer-to-peer exchange device, the most commodities discount to 100 people on the stores posters, the user can read the RFID within the posters by using the portable electronic device 2 of the electronic data exchange device 4, such that the personal information in the SIM card 3 or the SIM card information is exchanged with the discount information. When users bought the posters goods and paid debit via the electronic data exchange device, the billing will be discounted automatically. In addition, when the RFID on the posters is to be read once, the number of times will be accounted until added to 100 people.

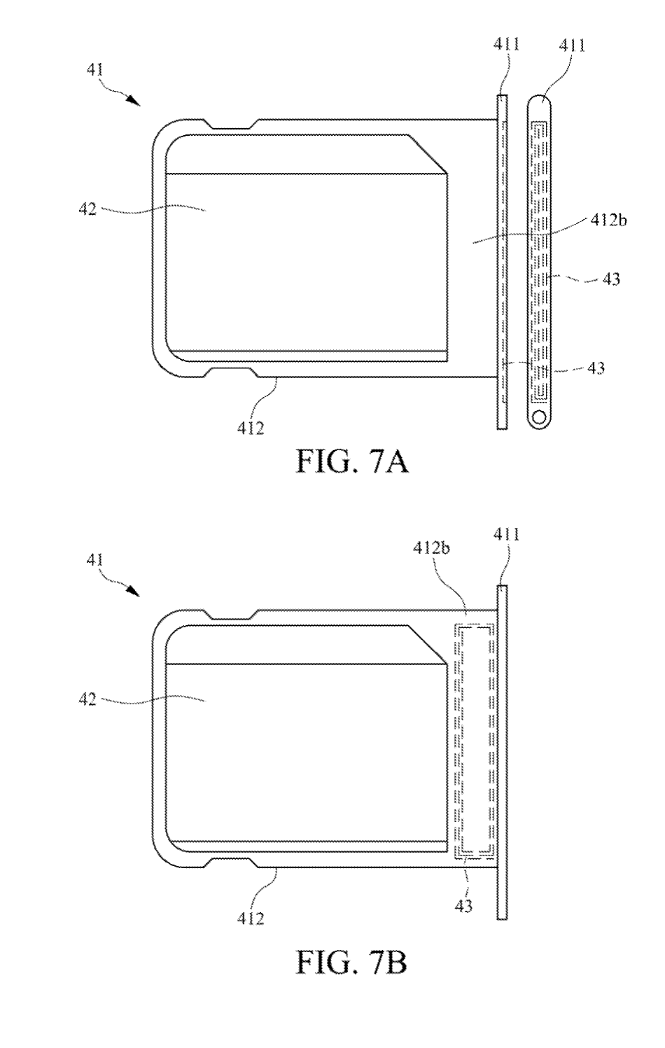

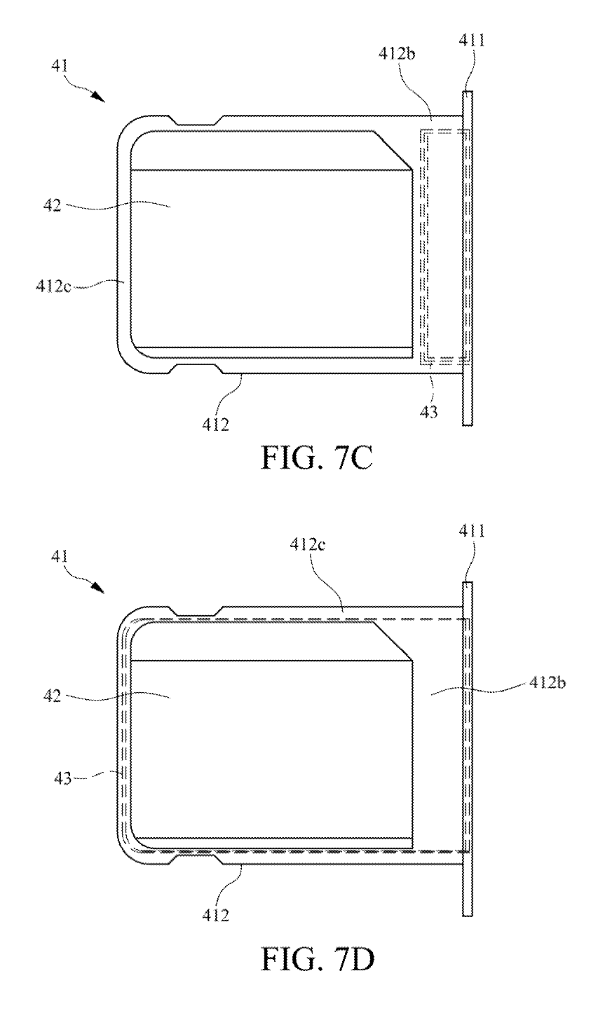

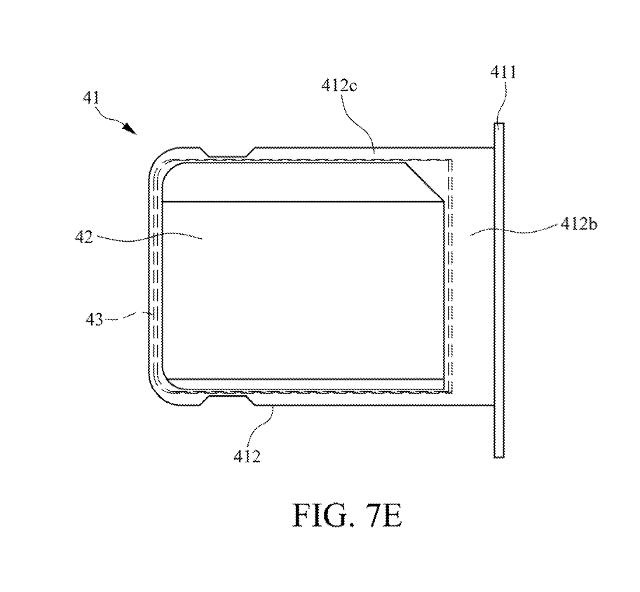

Please refer to FIG. 7 A to FIG. 7E. The antenna 43 can be disposed on the loading portion 41 at least five positions. Please refer with FIG. 1. The loading portion 41 includes a side plate 411 and a tray body 412 which is disposed on one side of the side plate 411. The tray body 412 includes an electrical contact region 42 and a connection portion 412b, in which the connection portion 412b is disposed between the side plate 411 and the electrical contact region 42. The periphery of the electrical contact region 42 of the tray body 412 is formed a frame 412c (as shown in FIG. 7C)

As shown in FIG. 7A, the antenna 43 is disposed on the side plate 411. When the loading portion 41 is positioned on the portable electronic device 2, the side plate 41 of the loading portion 41 will be exposed, which is an optimal position for operation of the antenna 43. As shown in FIG. 7B, the antenna 43 is disposed on the connection portion 412b of the tray body 412, in addition, the antenna 43 can also be disposed extendedly to the side plate 411. It is the second optimal position for operation of the antenna 43, as shown in FIG. 7E, the antenna 43 is disposed on the frame 412c of the tray body 412, and the antenna 43 can also be disposed extendedly to the side plate 411 through the connection portion 312b. It is the third optimal position for operation of the antenna 43.

The feature of the electronic data exchange device is applied for the portable electronic device of the present invention is that, the electronic data exchange device 4 can replace the SWP corresponding contact 211 of the SIM interface 21 to electrically connect with the SWP pin 31 of the SIM card. In addition, the electronic data exchange device 4 can replace the pre-remaining corresponding contact 213 of the SIM interface 21 to electrically connect with the pre-remaining pin 33 of the SIM card 3, such that the outer device (for example, a cash register of the billing system or the mobile telecommunications system, such as credit card or debit card) is communicated with or information interchange with the extended function module within the SIM card 3 through the electronic data exchange device 4 and the SWP pin 31 or two pre-remaining pin 33 of the SIM card. Thus, the electronic data exchange device 4 can combine with all kinds of the portable electronic device 4 without any external processor, and the electronic data exchange device 4 such as electronic payment device, a reader or peer to peer exchange device can achieve the multifunction in one machine. In addition, the electronic data exchange device 4 can dispose on the loading portion 41, in which the loading portion is provided for positioning the portable electronic device 2, such that eh SIM card 3, the electronic data exchange device 4 and the portable electronic device 2 can combine with each other. Thus, the structure of the portable electronic device should not be changed and the electrically connection before operation.

Although the present invention has been described with reference to the preferred embodiment thereof, it is apparent to those skilled in the art that a variety of modifications and changes may be made without departing from the scope of the present invention which is intended to be defined by the appended claims.

What is claimed:

1. An electronic data exchange device used for a portable electronic device with a SIM (Subscriber Identity Module) interface, said SIM interface is electrically connected with a SIM card, said electronic data device comprises:
a loading portion, said loading portion is provided for loading said SIM card, said loading portion includes an electrical contact region and is positioned on said portable electronic device such that said SIM card on said loading portion is electrically connected with said SIM interface through said electrical contact region; and
an exchange unit, said exchange unit having an antenna and an exchange module, wherein said antenna is disposed on and electrically connected with said loading portion, and said exchange module having the function of data exchange and data verification;
wherein said SIM card having a SWP pin, said exchange unit is electrically connected with said SWP pin of said SIM card through said electrical contact region and said SIM card is electrically isolated from said SWP corresponding contact of said SIM interface corresponding to said SWP pin.

2. The electronic data exchange device according to claim 1, wherein said electrical contact region includes an opening portion which is provided for exposing a plurality of pins of said SIM card, said exchange unit is electrically connected said SWP pin of said SIM card through said opening portion and is electrically isolated from said SWP corresponding contact of said SIM card interface.

3. The electronic data exchange device according to claim 1, wherein said electrical contact region includes a first contact interlace and a second contact interface which are disposed on two surfaces of said loading portion, said first contact interface includes a first surface corresponding contact corresponding to said SWP pin of said SIM card, said second contact interface includes a second surface corresponding contact corresponding to said SWP of said SIM interface, said exchange unit is electrically connected with said SWP pin of said SIM card through said first surface corresponding contact of said first contact interface, and said exchange unit is electrically isolated from said SWP corresponding contact of said SIM interface through said second surface corresponding contact of said second contact interface.

4. The electronic data exchange device according to claim 1, wherein said loading portion is a card tray.

5. The electronic data exchange device according to claim 1, wherein said electronic data exchange device is an electronic payment device, a reader, and a peer-to-peer exchange device.

6. The electronic data exchange device according to claim 1, wherein said loading portion includes a side plate and a tray body which is disposed on said side plate, said tray body includes an electrical contact region and a connection portion which is disposed between said side plate and said electrical contact region, the periphery of said electrical contact region of said tray body is formed a frame.

7. The electronic data exchange device according to claim 6, wherein said location of said antenna of said exchange unit is selected from the group consisting of a connection portion of said tray body of said loading portion and is extended to said side plate, said frame of said tray body of said loading portion and is extended to said side plate through said connection portion, and one of said frame of said tray body of said loading portion and said side plate of said loading portion.

8. An electronic data exchange device used for a portable electronic device with a SIM interface, said SIM interface is electrically connected with a SIM card, said electronic data exchange device comprises:
a loading portion, said loading portion is provided for loading said SIM card, said loading portion includes an electrical contact region and is positioned on said portable electronic device, such that said SIM card on said loading portion is electrically connected with said SIM interface through said electrical contact region;
an exchange unit, said exchange unit includes an antenna on said loading portion, and an exchange module is built in said SIM card and includes a function of data exchange and data verification;
wherein said SIM card includes two pre-remaining pins, said antenna is electrically connected with said two pre-remaining pins of said SIM card through said electrical contacting region and is electrically isolated from two pre-remaining corresponding contacts of said SIM interface corresponding to said two pre-remaining pins.

9. The electronic data exchange device according to claim 8, wherein said electrical contact region includes an opening portion to expose a plurality of pins of said SIM card, said antenna is electrically connected with said two pre-remaining pins of said SIM card through said opening portion, and is electrically isolated from said two pre-remaining corresponding contacts of said SIM interface.

10. The electronic data exchange device according to claim 8, wherein said electrical contact region includes a first contact interface and a second contact interface which are disposed on two surfaces of said loading portion, said first contact interface includes two first surface corresponding contacts corresponding to said two pre-remaining pins of said SIM card, said second contact interface includes two second surface corresponding contacts corresponding to said two pre-remaining pins of said SIM interface, said antenna is electrically connected with said two pre-remaining pins of said SIM card through said first surface corresponding contact of said first contact interface, and said antenna is electrically isolated from said two pre-remaining contacts of said SIM interface through said second surface corresponding contact of said second contact interface.

11. The electronic data exchange device according to claim 8, wherein said loading portion is a card tray.

12. The electronic data exchange device according to claim 8, wherein said electronic data exchange device is selected from the group consisting of an electronic payment device, a reader and a peer-to-peer exchange device.

13. The electronic data exchange device according to claim 8, wherein said loading portion includes a side plate and a tray body which is disposed on said side plate, said tray body includes an electrical contact region and a connection portion which is located between said side plate and said electrical contact region, and the periphery of said electrical contact region of said tray body is formed a frame.

14. The electronic data exchange device according to claim 13, wherein the location of said antenna of said exchange unit is selected from the group consisting of said connection portion of said tray body of said loading portion and is extended to said side plate, said connection portion of said tray body of said loading portion, said frame of said tray body of said loading portion and is extended to said side plate through said connection portion, said frame of said tray body of said loading portion and said side plate of said loading portion.
